(19) United States
(12) Patent Application Publication
(10) Pub. No.: US 2022/0215309 A1
(43) Pub. Date: Jul. 7, 2022

(54) INFORMATION PROCESSING APPARATUS, INFORMATION PROCESSING SYSTEM, INFORMATION PROCESSING METHOD, AND TERMINAL APPARATUS

(71) Applicant: TOYOTA JIDOSHA KABUSHIKI KAISHA, Toyota-shi (JP)

(72) Inventors: Toyokazu NAKASHIMA, Nagoya-shi (JP); Yurika TANAKA, Yokosuka-shi (JP); Shoji SAKAMOTO, Ichikawa-shi (JP); Yusuke KOBAYASHI, Ota-ku, Tokyo-to (JP); Kotaro OKABE, Ichikawa-shi (JP); Hirotada NAKANISHI, Toyota-shi (JP); Naoya OKA, Nagakute-shi (JP); Daiki OTANI, Nagoya-shi (JP)

(73) Assignee: TOYOTA JIDOSHA KABUSHIKI KAISHA, Toyota-shi, (JP)

(21) Appl. No.: 17/567,577

(22) Filed: Jan. 3, 2022

(30) Foreign Application Priority Data
Jan. 7, 2021 (JP) 2021-001668

(51) Int. Cl. G06Q 10/06; G08G 1/14

(52) U.S. Cl. CPC G06Q 10/06311; G06Q 2240/00; G08G 1/141

(57) ABSTRACT

An information processing apparatus includes a controller configured to: detect whether there is a standby user waiting in or in the vicinity of a parked vehicle based on parked vehicle information related to the parked vehicle; and output, to a terminal apparatus, referral information including information related to work to which the standby user is to be referred.

### CROSS-REFERENCE TO RELATED APPLICATION

This application claims priority to Japanese Patent Application No. 2021-001668, filed on Jan. 7, 2021, the entire contents of which are incorporated herein by reference.

### TECHNICAL FIELD

The present disclosure relates to an information processing apparatus, an information processing system, an information processing method, and a terminal apparatus.

### BACKGROUND

Systems for creating a market in which a worker who happens to be on the scene can be employed in real time on a spot basis using a positional information system are known (for example, Patent Literature 1).

### CITATION LIST

### Patent Literature

PTL 1: JP 2006-024156 A

### SUMMARY

Such a system as described above selects a worker who can arrive at the workplace by a certain time, based on the distance between the worker's current position and the workplace and on the difference between the current time and a work starting time. When a worker who is to be requested to provide their labor is selected based solely on the worker's current position and current time, and if the selected worker is unable to undertake the labor, it will be necessary to request another worker to provide the labor. There is a need to make it easier to arrange for a person who is to undertake the labor.

It would be helpful to make it easier to arrange for a person who is to undertake labor.

An information processing apparatus according to an embodiment of the present disclosure includes a controller configured to: detect whether there is a standby user waiting in or in the vicinity of a parked vehicle based on parked vehicle information related to the parked vehicle; and output, to a terminal apparatus, referral information including information related to work to which the standby user is to be referred.

An information processing system according to an embodiment of the present disclosure includes the information processing apparatus and the terminal apparatus.

An information processing method according to an embodiment of the present disclosure includes: acquiring parked vehicle information related to a parked vehicle that is parked; detecting whether there is a standby user waiting in or in the vicinity of the parked vehicle based on the parked vehicle information; and outputting, to a terminal apparatus, referral information including information related to work to which the standby user is to be referred.

A terminal apparatus according to an embodiment of the present disclosure includes an output interface and a controller. The output interface outputs information to a standby user waiting in or in the vicinity of a parked vehicle. The controller is configured to communicate with an information processing apparatus, and the controller acquires, from the information processing apparatus, referral information including information related to work to which the standby user is to be referred and causes the output interface to output the referral information.

According to the information processing apparatus, the information processing system, the information processing method, and the terminal apparatus according to an embodiment of the present disclosure, it is easier to arrange for a person who is to undertake labor.

### BRIEF DESCRIPTION OF THE DRAWINGS

In the accompanying drawings:

FIG. 1 is a schematic diagram illustrating an example configuration of an information processing system according to an embodiment;

FIG. 2 is a block diagram illustrating an example configuration of the information processing system according to the embodiment; and

FIG. 3 is a block diagram illustrating an example configuration of a terminal apparatus;

FIG. 4 is a flowchart illustrating an example procedure for an information processing method according to an embodiment; and

FIG. 5 is a flowchart illustrating an example procedure for a terminal control method according to an embodiment.

### DETAILED DESCRIPTION

(Example Configuration of Information Processing System 1)

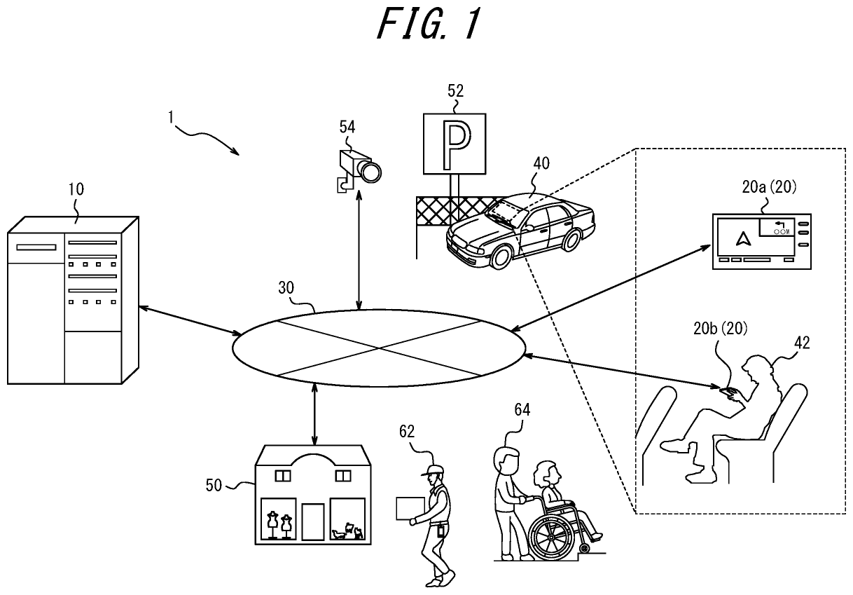

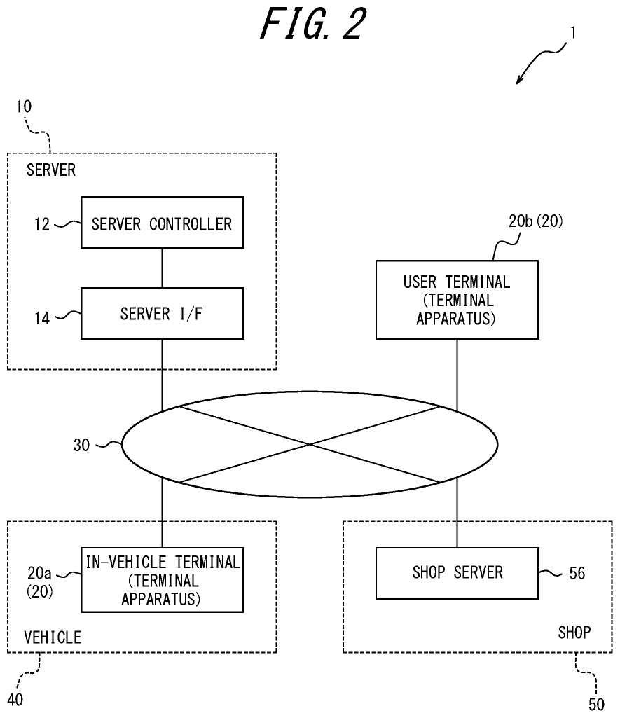

As illustrated in FIG. 1 and FIG. 2, an information processing system 1 according to an embodiment includes a server 10 and terminal apparatuses 20

In the information processing system 1 of the present embodiment, the server 10 can refer a user 42 who is waiting in or in the vicinity of a vehicle 40 parked in a parking area 52 to work that can be performed by the user 42 while they are waiting. The vehicle 40 parked in the parking area 52 is also referred to as a parked vehicle. The user 42 who is waiting in or in the vicinity of the parked vehicle is also referred to as a standby user. The standby user waiting in the vicinity of the parked vehicle may include the user 42 who is temporarily outside the parked vehicle so as to, for example, smoke or talk on the phone.

The server 10 generates referral information including information related to the work to which the standby user is to be referred and outputs the referral information to the terminal apparatus 20. By the terminal apparatus 20 notifying the standby user of the referral information, the standby user can be referred to the work. In a case in which the standby user who has been notified of the referral information is to undertake the work, the server 10 instructs the standby user to perform the work. The work can also be referred to as labor. The standby user who is to undertake the work is also referred to as a worker.

The parking area 52 may include a parking lot for a shop 50. The parking area 52 may include a variety of parking spaces, such as a parking space where parking duration is managed by coin-only parking meters, parking meters, or the like, or a parking space along a rotary outside a station. The parking area 52 may include a space where vehicles 40 for transporting passengers, such as taxis or hire cars, can park to wait for passengers.

For example, a standby user can be identified from the situation described below. For example, in a case in which the parking area 52 is a parking lot for the shop 50 or is located in the vicinity of the shop 50, a user 42 parks the vehicle 40 in the parking area 52 and uses the shop 50. In a case in which a plurality of users 42 is on board the vehicle 40, while some of the users 42 are using the shop 50 after getting out of the parked vehicle, the remaining users 42 in the vehicle 40 may wait in or in the vicinity of the parked vehicle. In this case, the users 42 waiting in or in the vicinity of the vehicle 40 fall into the category of a standby user. The standby users may include a driver who has driven the vehicle 40 to the parking area 52, or may include persons who have ridden on the vehicle 40 without driving the vehicle 40

For example, in a case in which the parking area 52 is located in the vicinity of a railroad station or bus stop, a user 42 may park the vehicle 40 in the parking area 52 so as to wait for a family member or the like who uses the railroad or bus. For example, in a case in which a vehicle 40 is a transportation vehicle for transporting passengers, such as a taxi or on-demand bus, a user 42, who is a driver of the vehicle 40, may park the vehicle 40 in the parking area 52 and wait until passengers arrive. In these cases, a user 42 waiting in or in the vicinity of the vehicle 40 falls into the category of a standby user. In various other cases, a user 42 waiting in or in the vicinity of the vehicle 40 may fall into the category of a standby user.

<Server 10>

The server 10 includes a server controller 12 and a server communication interface 14. The server interface 14 is also referred to as a server I/F 14.

The server controller 12 controls the components of the server 10. The server controller 12 is also referred to simply as a controller. The server controller 12 may configured with at least one processor. The “processor” is a general purpose processor, a dedicated processor that is dedicated to specific processing, or the like in the present embodiment but not limited to these. The server controller 12 may be configured with at least one dedicated circuit. Examples of dedicated circuits may include a field-programmable gate array (FPGA) and an application specific integrated circuit (ASIC). The server controller 12 may be configured with the dedicated circuit instead of the processor, or may be configured with the dedicated circuit along with the processor.

The server 10 may further include a memory. The memory may be, but is not limited to, a semiconductor memory, a magnetic memory, or an optical memory. The memory may function, for example, as a main memory, an auxiliary memory, or a cache memory. The memory may include an electromagnetic storage medium, such as a magnetic disk. The memory may include a non-transitory computer readable medium. The memory may store any information used for the operations of the server 10. For example, the memory may store a system program, an application program, or the like. The memory may be included in the server controller 12.

Information, data, or the like is outputted from and inputted to the server controller 12, through the server I/F 14. The server I/F 14 is also referred to simply as an interface or I/F.

The server I/F 14 may include a communication module for communication to other apparatuses, such as the terminal apparatuses 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The server I/F 14 may be configured to be connected to the communication module.

The server 10 may include a single server apparatus, or multiple server apparatuses capable of communicating with each other. The server 10 is also referred to as an information processing apparatus.

<Terminal Apparatus 20>

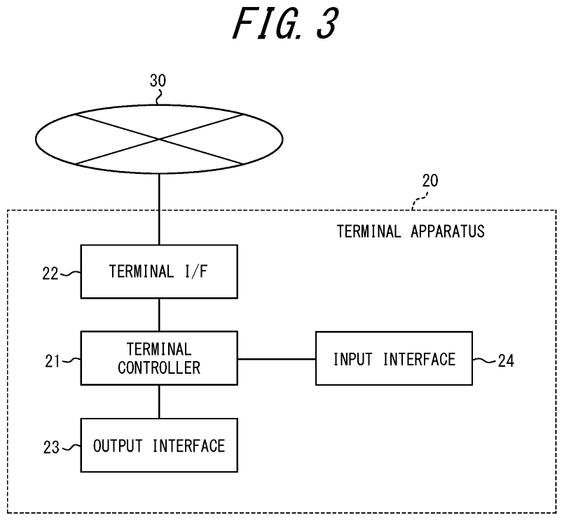

As illustrated in FIG. 3, each terminal apparatus 20 is provided with a terminal controller 21 and a terminal interface 22. The terminal interface 22 is also referred to as a terminal I/F 22.

The terminal controller 21 controls the components of the terminal apparatus 20. The terminal controller 21 is also referred to simply as a controller. The terminal controller 21 may be configured to be identical or similar to the server controller 12 of the server 10. The terminal controller 21 may configured with at least one processor. The terminal controller 21 may be configured with at least one dedicated circuit. Examples of dedicated circuits may include an FPGA and an ASIC. The server controller 21 may be configured with the dedicated circuit instead of the processor, or may be configured with the dedicated circuit along with the processor.

The terminal apparatus 20 may further include a memory. The memory of the terminal apparatus 20 may be configured to be identical or similar to the memory of the server 10. The memory may be, but is not limited to, a semiconductor memory, a magnetic memory, or an optical memory. The memory may function, for example, as a main memory, an auxiliary memory, or a cache memory. The memory may include an electromagnetic storage medium, such as a magnetic disk. The memory stores any information used for the operations of the terminal apparatus 20. For example, the memory may store a system program, an application program, or the like. The memory may be included in the terminal controller 21.

Information, data, or the like is outputted from and inputted to the terminal controller 21, through the terminal I/F 22. The terminal I/F 22 is also referred to simply as an interface or I/F.

The terminal I/F 22 may be configured to be identical or similar to the server I/F 14. The terminal I/F 22 may include a communication module for communication to other apparatuses, such as the server 10, via the network 30. The communication module may include, but is not limited to, a communication module compliant with a mobile communication standard, such as the 4th Generation (4G) standard or the 5th Generation (5G) standard. The terminal I/F 22 may be configured to be connected to the communication module.

The terminal apparatus 20 further includes an input interface 24. The input interface 24 may be configured with an input device for receiving inputs, such as information or data, from the user 42. The input device may be configured with, for example, a touch panel, a touch sensor, or a pointing device such as a mouse. The input device may be configured with a physical key. The input device may be configured with an audio input device, such as a microphone.

The input interface 24 may be configured to acquire positional information for the terminal apparatus 20 itself or the user 42. The input interface 24 may include a receiver compliant with a satellite positioning system. The receiver compliant with the satellite positioning system may include, for example, a Global Positioning System (GPS) receiver.

The input interface 24 may include a camera. The input interface 24 may acquire information related to the user 42 who is around by capturing an image of the surroundings using the camera. In a case in which the terminal apparatus 20 is mounted to the vehicle 40, the input interface 24 may acquire information related to the user 42 who is on board the vehicle 40.

The input interface 24 may output the acquired information to the server 10 via the terminal I/F 22. The terminal controller 21 may cause the information acquired through the input interface 24 to be outputted through the terminal I/F 22.

The terminal apparatus 20 further includes an output interface 23. The output interface 23 is configured with an output device that outputs information, data, or the like to the user 42. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The output interface 23 may output information that is acquired from the server 10 via the terminal I/F 22. The terminal controller 21 may cause the output interface 23 to output the information acquired through the terminal I/F 22.

The number of terminal apparatuses 20 included in the information processing system 1 is not limited to one and may be two or more. The terminal apparatuses 20 may include an in-vehicle terminal 20a that is mounted to the vehicle 40. The in-vehicle terminal 20a may be configured as a car navigation device that provides a navigation function of the vehicle 40. The terminal apparatuses 20 may include a user terminal 20B that is in the possession of the user 42. The user terminal 20b may include a mobile terminal, such as a smartphone or a tablet, or a Personal Computer (PC), such as a notebook PC or a tablet PC. The terminal apparatuses 20 are not limited to the above examples and may include various devices.

The user terminal 20b of the user 42 may be associated with the vehicle 40 boarded by the user 42. The user terminal 20b of the user 42 may be associated with the in-vehicle terminal 20a mounted to the vehicle 40 boarded by the user 42.

<Other Configurations>

The information processing system 1 further includes a surveillance camera 54, although this is not essential. The surveillance camera 54 captures an image of the vehicle 40 parked in the parking lot 52 and outputs the captured image to the server 10. As described later, the server 10 may detect whether there is a standby user based on the image captured by the surveillance camera 54.

The information processing system 1 further includes a shop server 56 that is installed in the shop 50, although this is not essential. The shop server 56 may be configured to be identical or similar to the server 10. As described later, the shop 50 may request work, such as delivery of products. In a case in which the shop 50 requests work, the shop server 56 may output work request information.

(Operation Example of Information Processing System 1)

The information processing system 1 according to the present embodiment notifies referral information to a standby user waiting in or in the vicinity of a parked vehicle. The referral information includes information related to work to which the standby user is to be referred as work that can be performed by the standby user while they are waiting. In the following, an example of the operations executed by the server 10 and the terminal apparatuses 20 of the information processing system 1 to notify a standby user of service information is described.

<Detection of Parked Vehicle and Standby User>

The server controller 12 acquires information related to a parked vehicle so as to detect a standby user waiting in or in the vicinity of the parked vehicle. Information related to a parked vehicle is also referred to as parked vehicle information. The server controller 12 detects a standby user waiting in or in the vicinity of a parked vehicle based on parked vehicle information.

The server controller 12 detects a parked vehicle. For example, the server controller 12 may acquire an image of the parking area 52 captured by the surveillance camera 54 as parked vehicle information. Based on the acquired image, the server controller 12 may detect a vehicle 40 parked in the parking area 52 as the parked vehicle. The server controller 12 may judge whether a vehicle 40 is parked in the parking lot 52, based on positional information for an in-vehicle terminal 20a mounted to the vehicle 40. When a vehicle 40 is parked in the parking lot 52, the server controller 12 may detect the vehicle 40 as the parked vehicle. The server controller 12 may judge whether a vehicle 40 is parked in the parking area 52 based on a result of detection by an apparatus for detecting vehicles 40, such as a parking meter, that is installed in the parking area 52. The server controller 12 may judge whether a vehicle 40 is parked in the parking area 52 based on various information without being limited to these examples.

The server controller 12 detects a standby user waiting in or in the vicinity of the parked vehicle based on parked vehicle information. For example, the server controller 12 may acquire an image of the parked vehicle captured by the surveillance camera 54 as the parked vehicle information. Based on the acquired image, the server controller 12 may detect a user 42 who is in or in the vicinity of the parked vehicle as the standby user.

The server controller 12 may acquire information outputted by the in-vehicle terminal 20a mounted to the vehicle 40 that has been detected as the parked vehicle as parked vehicle information. The server controller 12 may acquire an image of the inside of the parked vehicle from the in-vehicle terminal 20a and detect a user 42 who is in the parked vehicle as the standby user based on the image.

The server controller 12 may acquire information outputted by the vehicle 40 that has been detected as the parked vehicle or by a user terminal 20b associated with the in-vehicle terminal 20a mounted to the parked vehicle as parked vehicle information. The server controller 12 may acquire positional information for the user 42 from the user terminal 20b and detect the user 42 as the standby user when it is judged that the user 42 remains in or in the vicinity of the parked vehicle based on the positional information for the user 42.

In a case in which the user terminal 20b in the possession of the user 42 is associated with the vehicle 40 or with the in-vehicle terminal 20a mounted to the vehicle 40, the server controller 12 may acquire positional information for the user 42 from the user terminal 20b as parked vehicle information. The server controller 12 may judge that the user 42 falls into the category of a standby user when it is judged that the user 42 is in the parking area 52 based on the positional information for the user 42. That is, the server controller 12 may detect whether there is a standby user based on the positional information for the user 42 acquired from the user terminal 20b. The server controller 12 may judge that the user 42 falls into the category of a standby user when it is judged that the vehicle 40 is parked in the parking lot 52 based on positional information for the in-vehicle terminal 20a mounted to the vehicle 40 of the user 42 or the user terminal 20b. That is, the server controller 12 may detect whether there is a standby user, further based on the positional information for the in-vehicle terminal 20a mounted to the vehicle 40 of the user 42 or the user terminal 20b.

The server controller 12 may detect a user 42 who remains in or in the vicinity of the parked vehicle for a predetermined time period or longer as the standby user. The server controller 12 may detect a user 42 who remains within a predetermined distance from the parked vehicle as the standby user.

In a case in which the vehicle 40 is a taxi, the server controller 12 may detect a user 42, who is a driver of the vehicle 40, as the standby user, for example, when the vehicle 40 as a taxi is in an empty state.

The server controller 12 may detect a vehicle 40 that has been parked in a predetermined area for a predetermined time period or longer as the parked vehicle, without being limited to the above examples.

<Acquisition of Request Information>

The server controller 12 acquires request information including information related to work that can be requested from standby users so as to refer the standby users to the work.

As request information, the server controller 12 may acquire information related to product delivery work. The product delivery work may include, for example, the work of delivering, from a shop 50, products ordered from the shop 50. The information related to the delivery work from the shop 50 may be outputted from the shop server 56 of the shop 50. The information related to the delivery work may include the types or quantity of the products to be delivered. The information related to the delivery work may include information related to a point of origin and a destination for the delivery of the products. The information related to the delivery work may include an estimated amount of time required to complete the delivery.

As request information, the server controller 12 may acquire, for example, information related to the work of assisting persons in travelling. The work of assisting persons in travelling may include assisting those in need of assistance, such as elderly persons or disabled persons, in walking. The assisting in walking may include leading those in need of assistance by the hands. The assisting in walking may include walking with those in need of assistance while protecting them from people. The assisting persons may include the work of assisting in wheelchair rides. The assisting in wheelchair rides may include the work of pushing wheelchairs in areas that are not barrier-free, such as sidewalk steps. The work of assisting persons in travelling may include the work of assisting in travelling with walkers, strollers, or the like. The work of assisting persons in travelling may include the work of assisting persons in boarding and alighting from trains or buses.

As request information, the server controller 12 may acquire, for example, information related to the work of assisting in carrying luggage. The work of assisting in carrying luggage may include walking with those in need of assistance, such as parents with an infant, elderly persons, or disabled persons, while carrying luggage for them. The work of assisting in carrying luggage may include assisting in carrying walkers, strollers, or the like.

In a case in which request information includes assistant work, such as the work of assisting persons in travelling or the work of assisting in carrying luggage, the request information may be outputted to the server 10 from terminal apparatuses 20 in the possession of persons who are to receive the assistance. The server controller 12 may detect persons in need of assistance and generate request information by the server controller 12 itself. For example, the server controller 12 may acquire images from the surveillance camera 54 installed in the city. The server controller 12 may detect persons who are in need of assistance based on the appearances of the persons in the acquired images. The server controller 12 may generate information related to assistant work for those who are in need of assistance, as request information.

Request information may include information related to a reward to be granted to persons who have performed the requested work. The information related to the reward is also referred to as reward information. The reward may be determined by an entity requesting the work or by the server controller 12. An entity that bears the reward may be the entity that requests the work. In a case in which the server controller 12 generates request information, the entity that bears the reward may be an operator of the information processing system 1.

<Generation and Outputting of Referral Information>

Upon detecting a standby user waiting in or in the vicinity of a parked vehicle, the server controller 12 generates referral information including information related to work to which the standby user is to be referred and outputs the referral information to the terminal apparatus 20. The server controller 12 may generate the referral information, by determining the work to which the standby user is to be referred based on the acquired request information. In a case in which the request information includes reward information, the server controller 12 may generate referral information including the reward information.

«Selection of Standby User Who Is to Be Referred to Work»

Upon detecting a plurality of standby users, the server controller 12 may select a standby user who is to be referred to work based on the acquired request information. The server controller 12 generates referral information for referring the selected standby user to the work, and outputs the referral information to the terminal apparatus 20 of the selected standby user. The server controller 12 may judge whether each standby user is able to perform the work, and select a standby user who is to be referred to the work from standby users judged to be able to perform the work.

The server controller 12 may select a standby user who is to be referred to the work based on a time period during which each standby user is to wait. In other words, the server controller 12 may determine to which work each standby user is to be referred. Further, the server controller 12 may judge whether each standby user is able to perform the work within a time period during which the standby user is to wait, and select a standby user who is to be referred to the work from standby users who are judged to be able to perform the work. In other words, the server controller 12 may generate referral information so as to be able to refer a standby user to work that can be performed by the standby user within the wait time. The server controller 12 may acquire information related to a time period during which each standby user is to wait from their terminal apparatus 20.

The server controller 12 may estimate a time period during which each standby user is to wait and select a standby user who is to be referred to the work based on the estimated wait time. The server controller 12 may estimate a time period during which each standby user is to wait, as described specifically below. For example, the server controller 12 may estimate a time period during which a standby user is to wait based on information inputted by the standby user to the terminal apparatus 20 or on information notified to the standby user from the terminal apparatus 20. The information inputted by the standby user to the terminal apparatus 20 or the information notified from the terminal apparatus 20 to the standby user is also referred to as terminal information.

The terminal apparatus 20 may run a message application that allows the standby user to transmit and receive messages. The terminal apparatus 20 may output messages transmitted and received by the standby user on the message application to the server 10 as the terminal information. The server controller 12 may acquire the messages transmitted and received by the standby user as the terminal information, and estimate a time period during which the standby user is to wait based on the contents of the acquired messages. For example, in a case in which the standby user is going to pick up a certain person by vehicle 40, the server controller 12 may estimate a time period during which the standby user is to wait based on information on the arrival time included in a message that the standby user has received from the certain person. Specifically, in a case in which the standby user has received a message from the certain person that the certain person will arrive at around X o'clock, the server controller 12 may calculate a wait time for the standby user who is supposed to wait until around X o'clock. In a case in which the standby user has received a message from the certain person that they will be late for approximately Y minutes, the server controller 12 may calculate that the wait time for the standby user will take another Y minutes. The server controller 12 may estimate a time period during which the standby user is to wait based on the contents of messages transmitted and received between the standby user and the certain person.

In a case in which the parked vehicle is a vehicle 40 for transporting passengers and in which the standby user is to wait until the parked vehicle has been boarded by passengers, the server controller 12 may estimate a time period during which the standby user is to wait based on information that predicts whether passengers are likely to turn up. The server controller 12 may acquire the information that predicts whether passengers are likely to turn up from another server apparatus, such as a passenger prediction server. The passenger prediction server may predict whether passengers are likely to turn up, for example, based on a predetermined algorithm or on a learned model based on deep learning. The information that predicts whether passengers are likely to turn up may include the probability of passengers turning up at a predetermined time, or may include an expectation value of the time at which passengers are to turn up. The information that predicts whether passengers are likely to turn up may include the probabilities of passengers turning up at various locations.

The server controller 12 may select a standby user who is to be referred to the work based on information related to each standby user. The information related to each standby user may include, for example, attribute information, such as the age group or gender, for the standby user. The server controller 12 may acquire information related to a standby user from an in-vehicle terminal 20a mounted to the parked vehicle. The server controller 12 may acquire information related to a standby user from the user terminal 20b in the possession of the standby user. By selecting a standby user who is to be referred to the work based on the information related to each standby user, the selected standby user may be more likely to undertake the referred work.

For example, in a case in which the requested work is work for humans, such as caregiving, the server controller 12 may select a standby user who is to be referred to the work based on attribute information for a person for whom the work is to be performed. For example, the server controller 12 may select a standby user who is to be referred to the work so that the gender of the person to be assisted matches the gender of the standby user who is to be referred to the work.

The server controller 12 may select a standby user who is to be referred to the work based on ability required to perform the requested work.

For example, the server controller 12 may select a standby user based on information related to physical strength of each standby user in a case in which the standby user needs to have strength to move an object of a predetermined weight or more in order to perform the requested work. In a case in which the work requires strength, the server controller 12 may select a male standby user, or a standby user who belongs to a certain age group, such as that from the 20s to 40s.

The server controller 12 may select a standby user who is to be referred to the work based on various criteria. In other words, the server controller 12 may determine to which work a standby user is to be referred based on various criteria. The server controller 12 may select a standby user who is to be referred to the requested work so it will take less time before the requested work begins to be performed. The server controller 12 may select a standby user who is to be referred to the requested work so that the standby user will more likely to accept the referred work.

<Example Operations of Terminal Apparatus 20 That Have Acquired Referral Information>

Upon acquiring referral information from the server 10, the terminal apparatus 20 refers the standby user to the work by notifying the standby user of the referral information. Specifically, the terminal controller 21 of the terminal apparatus 20 acquires the referral information through the terminal I/F 22. The terminal controller 21 causes the output interface 23 to output the referral information, to thereby notify the standby user of the referral information.

The standby user decides whether to undertake or reject the work they have been referred to. For example, the standby user may reject the referred work because they believe that the work will not be done while they are waiting. In a case in which the referral information includes reward information, the standby user may reject the referred work, thinking that the reward is low for a description of the work. On the other hand, the standby user may undertake the work they have been referred to. The standby user's decision of whether to undertake or reject the referred work may be transmitted from the terminal apparatus 20 to the server 10. Specifically, the terminal controller 21 accepts, from the standby user, an input indicating a result of the decision on whether to undertake or reject the work they have been referred to, using the input interface 24. In a case in which it is determined that the standby user is to undertake the work they have been referred to, the terminal controller 21 outputs, to the server 10, acceptance information indicating that the standby user is to accept the referral and undertake the work. In a case in which the standby user is to reject the work they have been referred to, the terminal controller 21 may output, to the server 10, rejection information indicating that the standby user is to reject the work.

<Example Operations of Server 10 in Case in Which Referral Has Been Accepted>

In a case in which acceptance information has been acquired from the terminal apparatus 20, the server controller 12 recognizes that the standby user who has been referred to the work is to accept the referral and undertake the work. The server controller 12 may output work instructions including a specific description of the work or a specific execution procedure to the terminal apparatus 20 of the standby user who is to undertake the work. In a case in which the server controller 12 has outputted work instructions, the terminal apparatus 20 notifies the standby user of the work instructions. The standby user is to execute the work in accordance with the work instructions. After deciding to undertake the work, the standby user may perform the work based on information related to the work that is included in the referral information.

In a case in which the work is delivery work, the standby user who has undertaken the work may perform the delivery work as illustrated by a delivery person 62 in FIG. 1. In a case in which the work is assistant work, the standby user who has undertaken the work may perform the work of assisting in wheelchair rides as illustrated by an assistant 64 in FIG. 1.

Upon the standby user completing the work, a person who requested the work may transmit a completion report to the server 10. In a case in which the person who requested the work is in possession of a terminal apparatus 20, the completion report may be transmitted from the terminal apparatus 20 to the server 10.

In a case in which the work is delivery work requested by a shop 50, a completion report may be sent from the shop server 56 to the server 10. In a case in which the work is delivery work, a person who has received the delivered products may transmit a completion report to the server 10. In a case in which the person who has received the products is in possession of a terminal apparatus 20, the completion report may be transmitted from the terminal apparatus 20 to the server 10.

In a case in which the work is assistant work, a person who has received the assistance may transmit a completion report to the server 10. In a case in which the person who has received the assistance is in possession of a terminal apparatus 20, the completion report may be transmitted from the terminal apparatus 20 to the server 10. In a case in which the work is assistant work, the server controller 12 may recognize that the assistant work has been completed based on an image from the surveillance camera 54 and generate a completion report by the server controller 12 itself.

A completion report may include information indicating an evaluation of the work that has been performed. The information indicating the evaluation of the work is also referred to as evaluation information. The evaluation information may correspond to the degree of satisfaction of a person for whom the work has been performed. In a case in which the work is delivery work, the evaluation information may include, for example, an evaluation of conditions of delivered products, or may include an evaluation of the delivery speed. In a case in which the work is assistant work, the evaluation information may include, for example, an evaluation as to whether the assistant work has been performed smoothly.

Upon acquiring a completion report, the server controller 12 may grant a reward to the standby user who has performed the work. For example, the server controller 12 may grant points as the reward. As the reward, the server controller 12 may grant points that can be exchanged for valuables or a paid service provided at a related shop or another shop 50. The server controller 12 may grant electronic money as the reward. The server controller 12 may output payment information indicating cash payment as the reward.

The server controller 12 may grant a reward based on information related to the reward that is included in the request information in advance. The server controller 12 may change the amount of the reward based on evaluation information included in the completion report. For example, the server controller 12 may increase the reward in a case in which the performed work is highly evaluated.

<Example Operations of Server 10 in Case in Which Work Has Been Rejected>

In a case in which rejection information has been acquired from the terminal apparatus 20, the server controller 12 recognizes that the work is to be rejected by the standby user who has been referred to the work. In a case in which acceptance information has not been acquired from the terminal apparatus 20 for a predetermined time period after output of the referral information to the terminal apparatus 20, the server controller 12 may similarly recognize that the work is to be rejected by the standby user who has been referred to the work. In a case in which the work has been rejected by the standby user who has been referred to the work, the server controller 12 may select another standby user again and generate new referral information for referring the newly selected standby user to the work.

<Example Procedure for Information Processing Method>

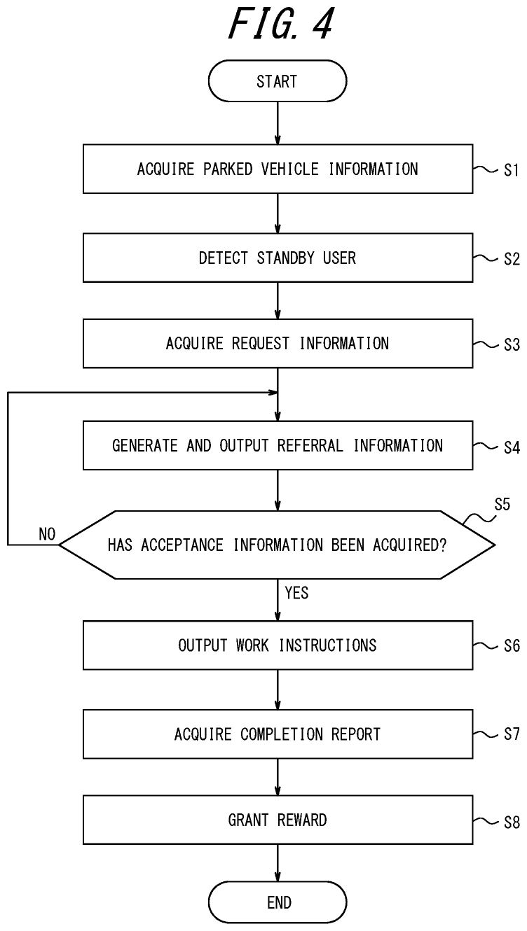

As described above, the information processing system 1 according to the present embodiment can notify referral information to a standby user and refer the standby user to work. The terminal controller 12 of the server 10 may execute an information processing method including, for example, a procedure shown in the flowchart illustrated in FIG. 4. The server controller 12 can generate and output the referral information to be notified to the standby user in a parked vehicle, by executing the illustrated information processing method. The information processing method may be implemented as an information processing program to be executed by the server controller 12.

The server controller 12 acquires parked vehicle information (Step S1). The server controller 12 detects a standby user based on the parked vehicle information (Step S2). The server controller 12 acquires request information (Step S3). The server controller 12 generates referral information to be notified to the detected standby user and outputs the referral information to the terminal apparatus 20 (Step S4).

The server controller 12 judges whether acceptance information has been acquired from the terminal apparatus 20 of the standby user (Step S5). If acceptance information has not been acquired (Step S5: NO), the server controller 12 returns to the procedure of Step S4.

If acceptance information has been acquired (Step S5: YES), the server controller 12 outputs work instructions (Step S6). The server controller 12 acquires a completion report (Step S7). The server controller 12 grants a reward to the standby user who has performed the work (Step S8). After executing the procedure in Step S8, the server controller 12 ends the execution of the procedure in the flowchart of FIG. 4.

<Example Procedure for Terminal Control Method>

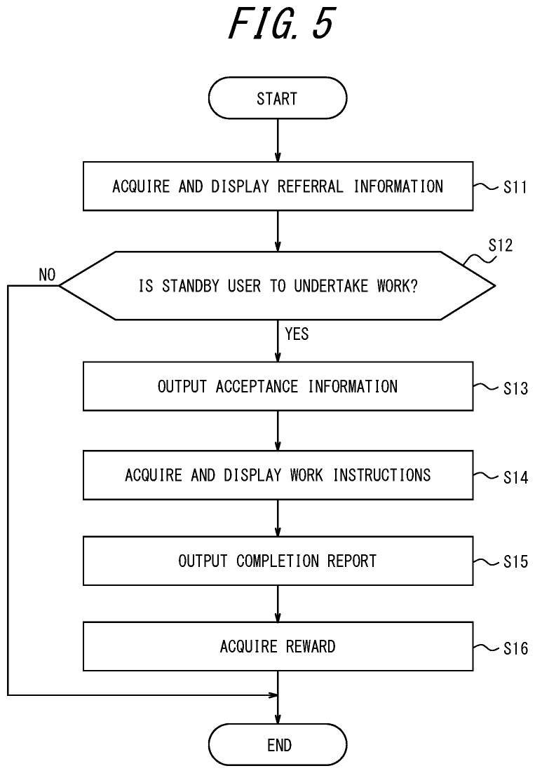

The terminal controller 21 of the terminal apparatus 20 may execute a terminal control method including, for example, a procedure shown in the flowchart illustrated in FIG. 5. By executing the illustrated terminal control method, the terminal controller 21 can notify the referral information to the standby user in the parked vehicle and prompt the standby user to accept and perform the work. The terminal control method may be implemented as a terminal control program to be executed by the terminal controller 21.

The terminal controller 21 acquires the referral information from the server 10 and causes the referral information to be displayed (Step S11). The terminal controller 21 judges whether the standby user is to undertake the work based on an input accepted from the standby user through the input interface 24 (Step S12). Specifically, the terminal controller 21 judges that the standby user is to accept the referral and undertake the work, by receiving an input indicating an intention of the standby user to undertake the work through the input interface 24. If the standby user is not to undertake the work (Step S12: NO), the terminal controller 21 ends the procedure of the flowchart in FIG. 5.

If the standby user is to undertake the work (Step S12: YES), the terminal controller 21 outputs acceptance information to the server 10 (Step S13). The terminal controller 21 acquires work instructions that has been generated by the server 10 upon receipt of the acceptance information, and causes the work instructions to be displayed (Step S14). The terminal controller 21 generates information indicating that the standby user has performed the work in accordance with the work instructions as a completion report and outputs it to the server 10 (Step S15). The terminal controller 21 acquires a reward granted by the server 10 that has acquired the completion report (Step S16), and ends the execution of the procedure of the flowchart in FIG. 5.

<Summary>

As described above, the information processing system 1 notifies a standby user waiting in or in the vicinity of a parked vehicle of referral information for referring the standby user to work. A standby user is likely to have spare time to perform work while they are waiting. By referring work to a standby user who is likely to have spare time to perform it, the referred work can be easily undertaken. Consequently, it may be easier to arrange for a standby user who is to undertake work.

(Other Embodiments)

Hereinafter, several other embodiments will be described.

<Order Acceptance>

The server controller 12 may acquire information for ordering products from a shop 50. The information for ordering products from the shop 50 is also referred to as order information. The server controller 12 may output the order information to the shop server 56. The server controller 12 may acquire information related to product delivery work from a shop 50 or a shop server 56 and generate referral information based on the acquired information. The server controller 12 may predict that product delivery work from a shop 50 is likely to take place based on order information and generate request information including information related to delivery work to be requested by the shop 50.

The server controller 12 may acquire order information that has been inputted by a standby user to the terminal apparatus 20. The server controller 12 may acquire information related to product delivery work from the shop 50 to the standby user and notify referral information to another standby user. The standby user who inputs the order information is also referred to as a first standby user. The standby user who is referred to delivery work based on the order information from the first standby user is also referred to as a second standby user. The server controller 12 may acquire the order information from the terminal apparatus 20 of the first standby user and output, to the terminal apparatus 20 of the second standby user, the referral information for the delivery work that is to take place based on the order information from the first standby user.

The server controller 12 may acquire request information from the shop server 56 of a shop 50 that is associated with the parking area 52 in which a parked vehicle is parked. The shop 50 that is associated with the parking area 52 is also referred to as a related shop. The server controller 12 may acquire order information for ordering products from the related shop.

<Configuration of Server Apparatus>

The server 10 may include different server apparatuses for different operations. For example, the server 10 may include a server apparatus that detects a standby user, a server apparatus that generates request information, and a server apparatus that generates referral information based on the request information, as separate apparatuses.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising a controller configured to:
detect whether there is a standby user waiting in or in the vicinity of a parked vehicle based on parked vehicle information related to the parked vehicle; and
output, to a terminal apparatus, referral information including information related to work to which the standby user is to be referred.

2. The information processing apparatus according to claim 1, wherein the controller is configured to determine the work to which the standby user is to be referred, based on a time period during which the standby user is to wait.

3. The information processing apparatus according to claim 2, wherein the controller is configured to determine work that can be performed by the standby user while the standby user is waiting, as the work to which the standby user is to be referred.

4. The information processing apparatus according to claim 2, wherein the controller is configured to estimate the time period during which the standby user is to wait, based on terminal information including information inputted by the standby user to the terminal apparatus or information notified from the terminal apparatus to the standby user.

5. The information processing apparatus according to claim 4, wherein the controller is configured to estimate the time period during which the standby user is to wait, based on information related to messages transmitted and received by the standby user as the terminal information.

6. The information processing apparatus according to claim 2, wherein, in a case in which the parked vehicle is a vehicle for transporting a passenger and in which the standby user is to wait until the parked vehicle has been boarded by a passenger, the controller estimates the time period during which the standby user is to wait based on information that predicts whether a passenger is likely to turn up.

7. The information processing apparatus according to claim 1, wherein the controller is configured to acquire request information including information related to work that can be requested from the standby user and determine the work to which the standby user is to be referred based on the request information.

8. The information processing apparatus according to claim 7, wherein the controller is configured to acquire information related to product delivery work as the request information.

9. The information processing apparatus according to claim 8, wherein the controller is configured to acquire order information for ordering a product from a shop and output information related to work of delivering the product from the shop.

10. The information processing apparatus according to claim 7, wherein the controller is configured to acquire information related to work of assisting a person in travelling and/or work of assisting in carrying luggage, as the request information.

11. The information processing apparatus according to claim 1, wherein the controller is configured to detect a vehicle that has been parked in a predetermined area for a predetermined time period or longer as the parked vehicle.

12. An information processing system comprising:
the information processing apparatus according to claim 1; and
the terminal apparatus.

13. An information processing method, comprising:
acquiring parked vehicle information related to a parked vehicle that is parked;
detecting whether there is a standby user waiting in or in the vicinity of the parked vehicle based on the parked vehicle information; and
outputting, to a terminal apparatus, referral information including information related to work to which the standby user is to be referred.

14. The information processing method according to claim 13, further comprising determining the work to which the standby user is to be referred, based on a time period during which the standby user is to wait.

15. The information processing method according to claim 13, further comprising estimating the time period during which the standby user is to wait, based on terminal information including information inputted by the standby user to the terminal apparatus or information notified from the terminal apparatus to the standby user.

16. The information processing method according to claim 13, further comprising, in a case in which the parked vehicle is a vehicle for transporting a passenger and in which the standby user is to wait until the parked vehicle has been boarded by a passenger, estimating the time period during which the standby user is to wait based on information that predicts whether a passenger is likely to turn up.

17. The information processing method according to claim 13, further comprising:
acquiring request information including information related to work that can be requested from the standby user; and
determining the work to which the standby user is to be referred based on the request information.

18. The information processing method according to claim 17, comprising acquiring information related to product delivery work, work of assisting a person in travelling, and/or work of assisting in carrying luggage, as the request information.

19. A terminal apparatus comprising:
an output interface configured to output information to a standby user waiting in or in the vicinity of a parked vehicle; and
a controller configured to communicate with an information processing apparatus and configured to acquire, from the information processing apparatus, referral information including information related to work to which the standby user is to be referred and cause the output interface to output the referral information.

20. The terminal apparatus according to claim 19, further comprising an input interface configured to accept an input from the standby user, wherein the controller outputs acceptance information to the information processing apparatus in a case in which an input indicating an intention of the standby user to undertake the work based on the referral information has been acquired through the input interface.
